(19) United States
(12) Patent Application Publication
(10) Pub. No.: US 2014/0188537 A1
(43) Pub. Date: Jul. 3, 2014

(54) SYSTEM AND METHOD FOR CROWDSOURCING MAP PRODUCTION

(71) Applicant: PRIMORDIAL, Saint Paul, MN (US)

(72) Inventors: Randy Len Milbert, Saint Paul, MN (US); Andreas Owkin Robinson, Saint Paul, MN (US)

(73) Assignee: PRIMORDIAL, Saint Paul, MN (US)

(21) Appl. No.: 13/733,132

(22) Filed: Jan. 2, 2013

(51) Int. Cl. G06Q 10/06

(52) U.S. Cl. CPC G06Q 10/063112
USPC 705/7.14; 705/7.13; 705/7.41

(57) ABSTRACT

A system, method, and computer program product for producing maps, including a client module for dividing a map production job into smaller tasks; and a worker module for enabling workers to perform said tasks. A test module is provided for enforcing quality standards and includes a qualification module for verifying that a worker is qualified to work on a task, a binary test module for prompting workers to review and pass or fail a submission, a comparative test module for assigning a task to multiple workers and comparing the results, a defacing module for introducing errors into submissions, a client review module for enabling a client to review and pass or fail a submission, and/or an eligibility module for preventing failing workers from contributing to a job.

### BACKGROUND OF THE INVENTION

1. Field of the Invention

The present disclosure relates to methods and systems for map production, and more particularly to methods and systems for map production, including dividing a large map production job into small tasks, assigning the tasks to multiple workers, automatically enforcing quality standards, and producing a seamless high-quality output, and the like.

2. Discussion of the Background

In recent years, systems and methods for crowdsourcing, including web sites for paid online crowdsourcing, and the like, have become popular. However, such existing systems and methods for crowdsourcing do not adequately support map production, and the like. Therefore, there is a need for a method and system for map production that addresses the above and other problems, and provides mechanisms for splitting map production jobs into small tasks, enforcing quality standards, assembling results, and the like.

### SUMMARY OF THE INVENTION

The above and other needs are addressed by illustrative embodiments of the present invention, which provide a system, method, and computer program for leveraging multiple workers to rapidly produce high-quality maps, and the like. The illustrative system, method, and computer program product can include a client module, worker module, test module, and database. The client module enables a client to log into the system and create a job, and divides the map production job into smaller tasks. The worker module enables a worker to log into the system and perform these tasks. The test module automatically enforces quality standards, and includes a qualification module, binary test module, comparative test module, defacing module, client review module, and eligibility module. The system also includes a database including client, worker, and job information.

Accordingly, in illustrative aspects, there are provided systems, methods and computer program products for producing maps, including a client module for dividing a map production job into smaller tasks; and a worker module for enabling workers to perform the tasks.

A test module is provided for enforcing quality standards.

The test module includes at least a qualification module for verifying that a worker is qualified to work on a task, a binary test module for prompting workers to review and pass or fail a submission, a comparative test module for assigning a task to multiple workers and comparing the results, a defacing module for introducing errors into submissions, a client review module for enabling a client to review and pass or fail a submission, and an eligibility module for preventing failing workers from contributing to a job.

In further illustrative aspects, there are provided systems, methods and computer program products for producing maps, including a test module for enforcing quality standards. The test module includes at least a qualification module for verifying that a worker is qualified to work on a task, a binary test module for prompting workers to review and pass or fail a submission, a comparative test module for assigning a task to multiple workers and comparing the results, a defacing module for introducing errors into submissions, a client review module for enabling a client to review and pass or fail a submission, and an eligibility module for preventing failing workers from contributing to a job.

A client module is provided for dividing a map production job into smaller tasks; and a worker module is provided for enabling workers to perform the tasks.

Still other aspects, features, and advantages are readily apparent from the following detailed description, by illustrating a number of illustrative embodiments and implementations. The present disclosure is also capable of other and different embodiments, and its several details can be modified in various respects, all without departing from the spirit and scope of the present disclosure. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings in which like reference numerals refer to similar elements and in which:

FIG. 1 is an illustrative system and method for map production;

FIG. 2 shows further details of the illustrative system and method for map production of FIG. 1;

FIG. 3 shows further details of a client module of the illustrative system and method of FIG. 2;

FIG. 4 shows further details of a worker module of the illustrative system and method of FIG. 2;

FIG. 5 shows further details of a test module of the illustrative system and method of FIG. 2;

FIG. 6 shows further details of a qualification module of the illustrative system and method of FIG. 5;

FIG. 7 shows further details of a binary test module of the illustrative system and method of FIG. 5;

FIG. 8 shows further details of a comparative test module of the illustrative system and method of FIG. 5;

FIG. 9 shows further details of a defacing module of the illustrative system and method of FIG. 5;

FIG. 10 shows further details of a client review module of the illustrative system and method of FIG. 5;

FIG. 11 shows further details of an eligibility module of the illustrative system and method of FIG. 5; and

FIG. 12 shows further details of a comparison module of the illustrative system and method of FIG. 5.

### DETAILED DESCRIPTION OF THE ILLUSTRATIVE EMBODIMENTS

The present disclosure includes recognition that web sites for paid online crowdsourcing, such as Amazon Mechanical Turk (e.g., available on the world wide web at mturk.com), and the like, have become popular in recent years. Such web sites enable a client to login and post a job comprised of small tasks that workers receive a fee to complete. The client has the option to review and pass or fail worker submissions. The submissions automatically pass after a configurable time period. The client pays only for passed submissions. Amazon Mechanical Turk is a general purpose task-based crowdsourcing platform. Clients use it for a variety of jobs such as translating documents and assigning keywords to images. It provides the greatest advantages when the posted tasks are simple for humans but difficult for computers.

By experimenting with Amazon Mechanical Turk for map production, it was discovered that such a system had no built-in mechanisms for splitting map production jobs into small tasks, enforcing quality standards, or assembling the results. By contrast, an illustrative embodiment of the present disclosure includes a crowdsourcing geographic information system (GIS) platform. The illustrative embodiment splits large map production jobs into small tasks and assigns them to multiple workers. To ensure consistency across the map, the illustrative embodiment also displays adjacent submissions to a worker performing a task and performs automatic vertex snapping, and the like. The illustrative embodiment also includes a suite of test modules for enforcing quality standards.

Other platforms, such as Google Map Maker (e.g., available on the world wide web at google.com/mapmaker), Open Street Map (e.g., available on the world wide web at openstreetmap.org), TomTom Map Share (e.g., available on the world wide web at tomtom.com/en_gb/maps/map-share/), and Nokia Map Creator (e.g., available on the world wide web at maps.nokia.com/mapereator/), and the like, enable volunteers to contribute to maps, but they lack the payment system, quality assurance modules, and other features of the present disclosure. They also provide no means for a third-party client to login and post a map production task. Instead, they focus on improving existing maps provided by Google, Open Street Map, TomTom, and Nokia.

Generally, the illustrative system and method include a client module, worker module, test module, and database. The client module enables a client to log into the system and create a job (e.g., digitizing trails visible in satellite imagery in Como Park). The worker module enables a worker to log into the system and perform tasks (e.g., digitizing trails visible in individual imagery tiles within Como Park). The worker module also verifies that a worker is qualified to work on a selected task. If not, it invokes a qualification module. The test module automatically enforces quality standards. It includes a qualification module, binary test module, comparative test module, defacing module, client review module, and eligibility module. The qualification module verifies that a worker can reliably perform a task before he or she qualifies to work on a job. The qualification module presents the worker with tasks that have known correct answers and ensures that the worker produces results that closely match these answers. The qualification module relies on a comparison module to assess similarity between two submissions. The binary test module presents a worker's submission to two different workers and prompts them to review and then pass or fail the submission. If they disagree, the system spawns a third task for a worker to review the submission. The submission passes if two workers pass it, and otherwise, it fails. The comparative test module assigns each task to two workers and compares the results using the comparison module. If the worker submissions match, they pass. Otherwise, the comparative test module spawns additional tasks until it finds two submissions that match. The system passes the submissions that match and fails the rest. The defacing module introduces error into submissions that have passed binary and comparative tests and presents the defaced submissions to workers as binary test tasks. If a worker passes a defaced submission, the system presents an error message and treats the mistake as a failed submission. The client review module enables the client who posted a job to review and pass or fail worker submissions. The eligibility module prevents a worker from contributing to a job if his or her failure percentage exceeds a threshold. Specifically, after a grace period of five tasks per job, a worker with more than a 25% failure rate becomes ineligible to work on the job. The comparison module determines whether two submissions match. Specifically, it rasterizes and downsamples each submission by 4×. It then determines the overlap among pixels corresponding to features drawn by workers. If the false positive and false negative rates are less than 5%, the module indicates that the inputs match, and otherwise, it indicates that the inputs differ.

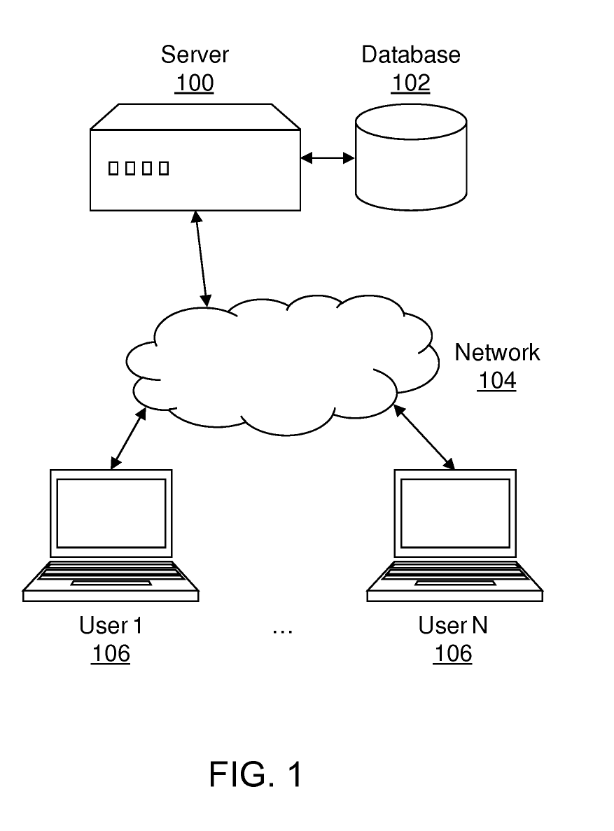

Referring now to the drawings, wherein like reference words designate identical or corresponding parts throughout the several views, FIG. 1 is an illustrative system and method for map production. In FIG. 1, the illustrative system and method can include a server 100 that accesses information in a database 102. A network 104 (e.g., wired or wireless) connects users 106 to the server 100.

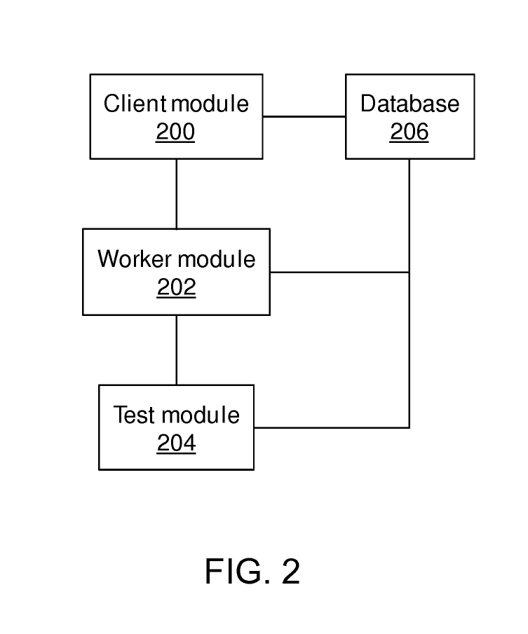

FIG. 2 shows further details of the illustrative system and method for map production of FIG. 1. In FIG. 2, a client module 200 enables a client to log into the system and create a job. A worker module 202 enables a worker to log into the system and perform tasks. A test module 204 automatically enforces quality standards. Each of these modules accesses a database 206, for example, including client, worker, job information, and the like.

The current system uses Microsoft ASP.NET 3.5, Microsoft SQL Server 2008, Internet Information Services (IIS) 7.0, jQuery 1.8.1, and Earthmine SDK for Flash 1.8.4. It includes C#, JavaScript, hypertext markup language (HTML), cascading style sheet (CSS), and ActionScript code. One skilled in the art will recognize that one could implement the present disclosure using a variety of frameworks, languages, and databases.

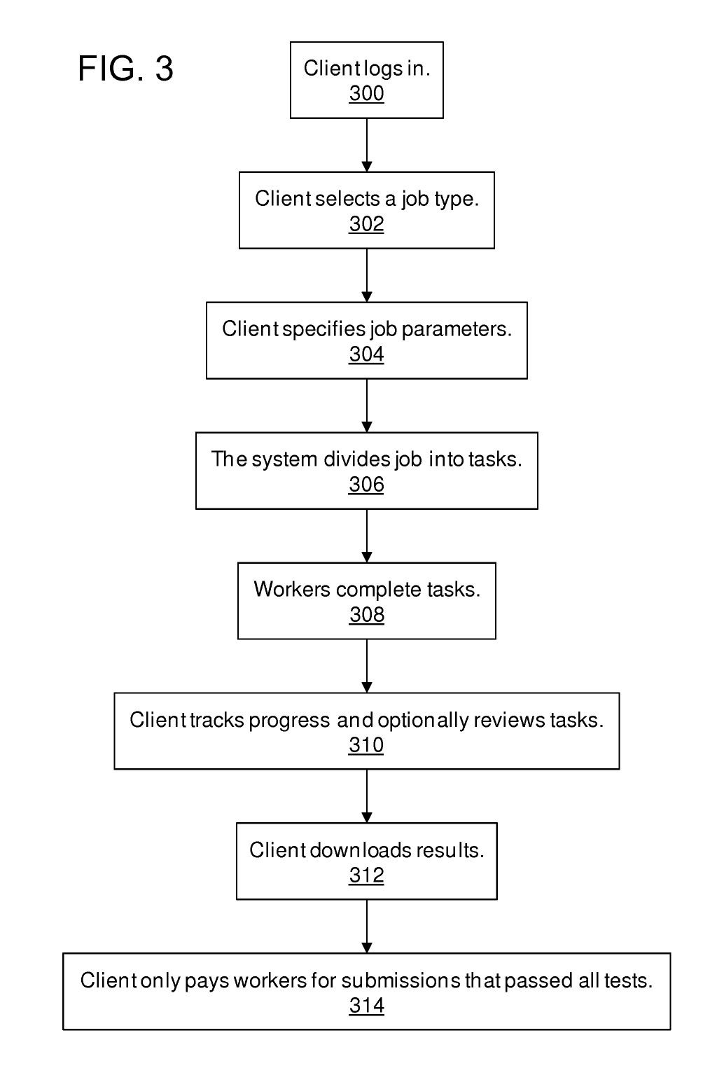

FIG. 3 shows further details of a client module of the illustrative system and method of FIG. 2. In FIG. 3, the client module 200 begins at step 300 by prompting a client to login. At step 302, the client selects a job type. The current system supports three job types: draw borders, draw features, and add metadata. For draw borders jobs, a worker draws a border around a large area such as an urban park or parking lot. For draw features jobs, a worker digitizes features such as trails within overhead or ground imagery. For add attributes jobs, a worker specifies a feature's attributes. For example, a worker might specify the species and age of a tree. At step 304, the client specifies job parameters. For draw borders jobs, the client specifies a title, instructions, an imagery source, and a keyhole markup language (KML) file including points. The current system supports the following imagery sources: Google tile repository, Earthmine server, and Web Map Service (WMS). One skilled in the art will recognize that one could implement the present disclosure using a variety of imagery sources. For draw features jobs, the client specifies a title, instructions, a shape (point, line, or polygon), whether or not to snap nearby vertices together, an imagery source, and a KML file including borders. When snapping is enabled, the current system snaps together vertices within five meters of each other. The snapping distance is configurable. For add attributes jobs, the client specifies a title, instructions, an attribute list, an imagery source, and a KML file including features. Each attribute list element is comprised of a name (e.g., species) and a valid values list (e.g., ash, oak, pine). At step 306, the system divides the job into tasks. For draw borders jobs, the system creates one task for each point in the KML file. For draw features jobs, the system divides each area specified in the input KML file into 512 by 512 pixel tiles and creates a task corresponding to each tile. For add attributes jobs, the system creates one task for each feature in the input KML file. At step 308, workers complete the tasks using the worker module 202 while the test module 104 enforces quality standards. At step 310, the client tracks progress and optionally reviews tasks using the client review module 508. At step 312, once workers have successfully completed all of the tasks, the system enables the client to download the results. For draw borders jobs, this is a KML file including polygons representing borders. For draw features jobs, this is a KML file including points, lines, or polygons representing features. For add attributes jobs, this is a KML file including features with attributes specified in a description tag. At step 314, the system pays workers for submissions that passed all of the tests.

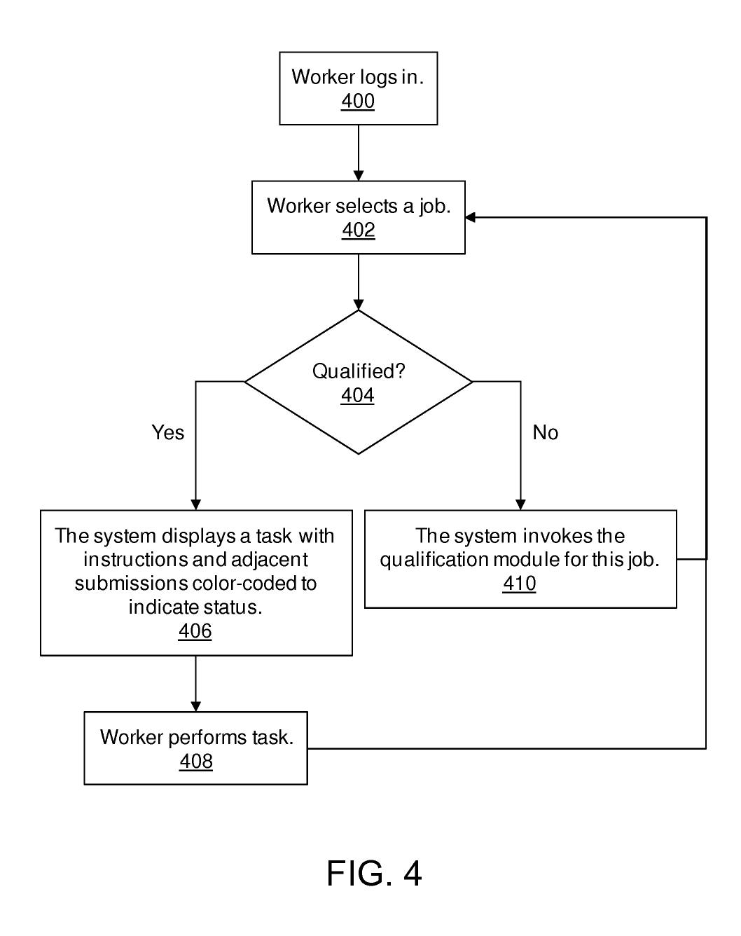

FIG. 4 shows further details of a worker module of the illustrative system and method of FIG. 2. In FIG. 4, the worker module 202 begins at step 400 by prompting a worker to login. At step 402, the worker selects a job to work on (e.g., digitizing trails in Como Park). At step 404, the worker module 202 checks whether the worker is qualified to work on the job. If so, the worker module 202 advances to step 406 and displays a task with instructions for completing it. For draw features jobs, the system also displays adjacent worker submissions color-coded to indicate status (e.g., pending or approved). At step 408, the worker performs the task. The worker module 202 then returns to step 402 where the worker can perform additional tasks for the current job or select a different job to work on. If, at step 404, the worker is unqualified to work on a selected job, the worker module 202 invokes the appropriate qualification module 500. The current system has qualification modules for different job types (e.g., drawing trails in overhead imagery and identifying boulevard trees in ground imagery). When the qualification module 500 completes, the worker module 202 returns to step 402.

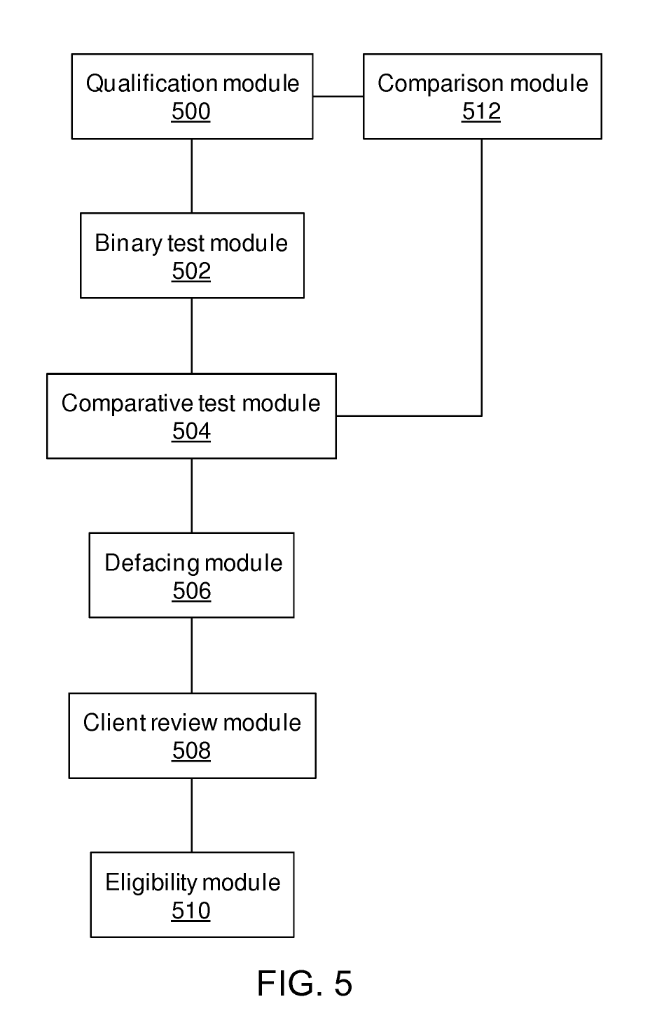

FIG. 5 shows further details of a test module of the illustrative system and method of FIG. 2. In FIG. 5, test module 204 can include a qualification module 500 that enables a worker to qualify to work on jobs of a certain type. A binary test module 502 prompts workers to review a submission and pass or fail it. A comparative test module 504 assigns identical tasks to multiple workers and automatically compares the results. A defacing module 506 introduces errors into submissions that have passed binary and comparative tests and then presents the defaced submissions to workers as a binary test. The defacing module 506 penalizes workers that pass the defaced submissions. A client review module 508 enables a client to optionally pass or fail worker submissions. An eligibility module 510 tracks each worker's failure rate while working on a job and prevents the worker from contributing to a job if the failure rate exceeds a threshold. A comparison module 512 compares two worker submissions and returns a result indicating whether they match.

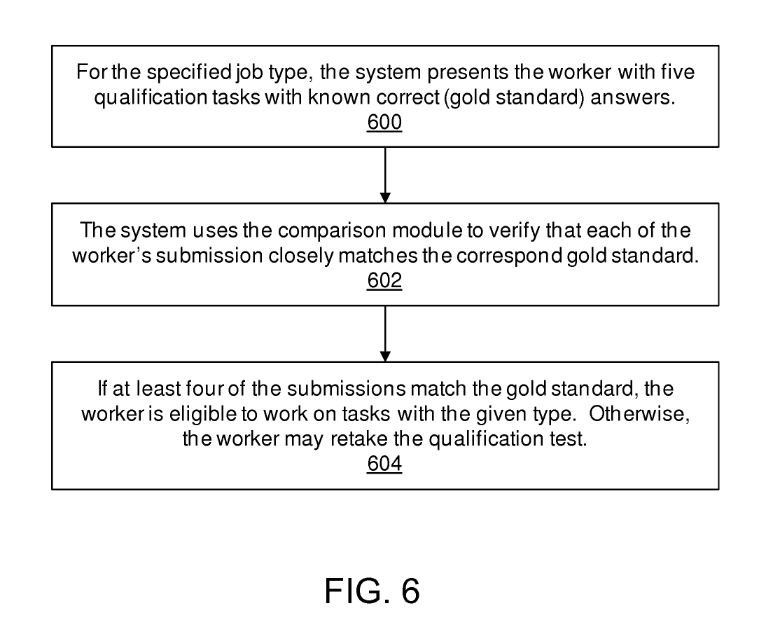

FIG. 6 shows further details of a qualification module of the illustrative system and method of FIG. 5. In FIG. 6, the qualification module 500 starts at step 600 by presenting the worker with five qualification tasks with known correct (a.k.a. gold standard) answers. At step 602, the qualification module 500 uses the comparison module 512 to verify that each of the worker's submissions closely matches the corresponding gold standard. At step 604, if at least four of the submissions match the corresponding gold standard, the qualification module 500 returns indicating that the worker is eligible to work on jobs with the specified type. Otherwise, the qualification module prompts the worker to retake the qualification test. The qualification module 500 supports configuring a variety of parameters including the number of qualification tasks, the percent correct required to qualify, and the false negative and false positive thresholds used by the comparison module 512.

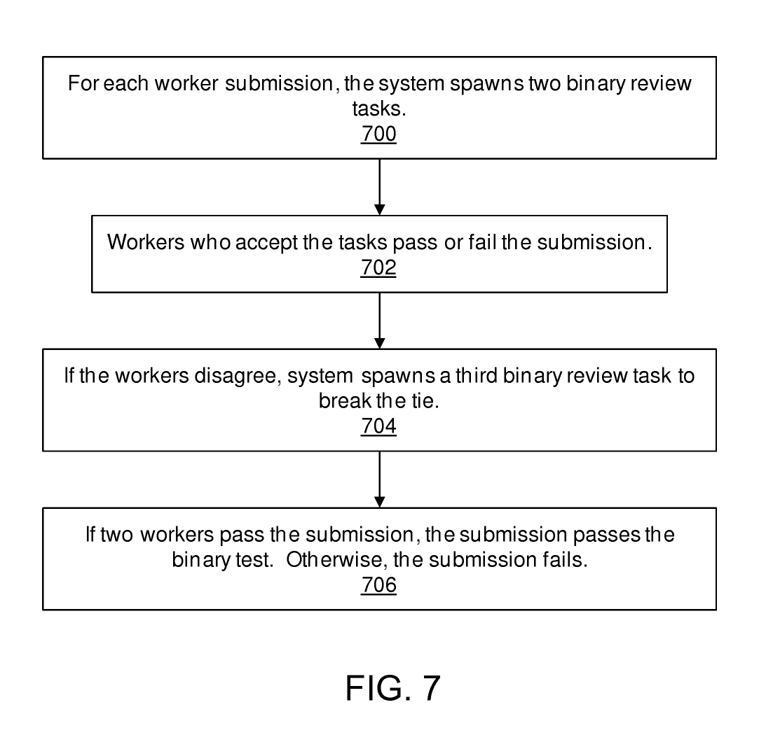

FIG. 7 shows further details of a binary test module of the illustrative system and method of FIG. 5. In FIG. 7, the binary test module 502 starts at step 700 by spawning two binary review tasks for each worker submission. At step 702, workers who accept the tasks pass or fail the submission. At step 704, if the two workers disagree, the system spawns a third binary review task to break the tie. At step 706, the binary test module 502 determines if two workers passed the submission. If so, the binary test module 502 returns indicating that the submission passed. Otherwise, the binary test module 502 returns indicating that the submission failed. The binary test module 502 supports configuring a variety of parameters including the percentage of submissions that undergo binary testing, the number of reviewers, and the percentage or workers that must agree to pass or fail a submission.

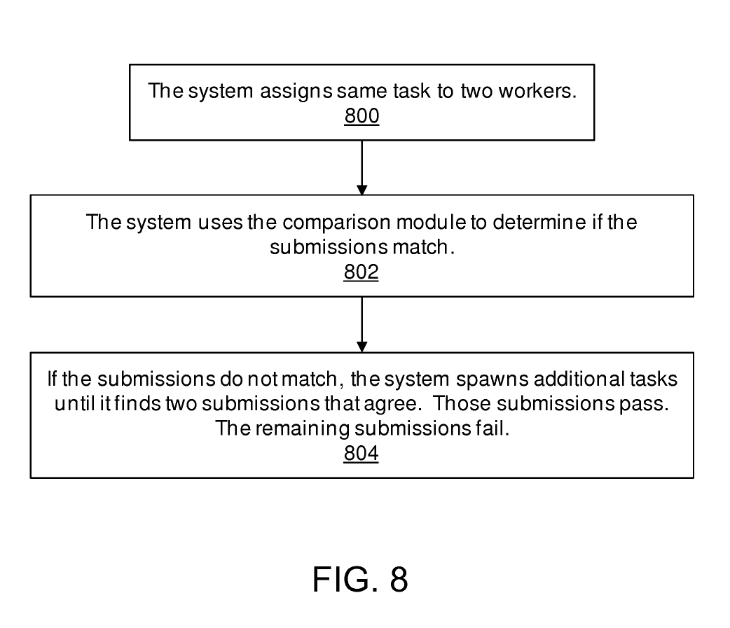

FIG. 8 shows further details of a comparative test module of the illustrative system and method of FIG. 5. In FIG. 8, the comparative test module 504 starts at step 800 by assigning the same task to two workers. At step 802, the comparative test module 504 uses the comparison module 512 to determine if the submissions match. At step 804, if the submissions do not match, the system spawns additional tasks until it finds two submissions that match. The comparative test module 504 passes the submissions that match and fails the rest. The comparative test module 504 supports configuring a variety of parameters including the percentage of submissions that undergo comparative test and the number of redundant assignments.

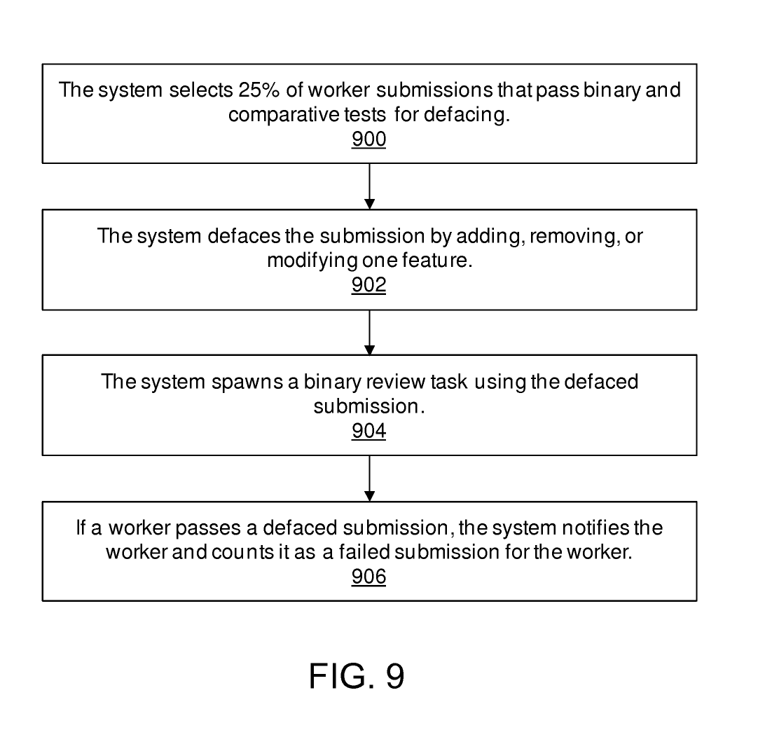

FIG. 9 shows further details of a defacing module of the illustrative system and method of FIG. 5. In FIG. 9, the defacing module 506 starts at step 900 by selecting 25% of worker submissions that pass the binary and comparative tests for defacing. At step 902, the defacing module 506 defaces the selected submission. To deface a submission, the defacing module 506 first randomly selects a deface method from the following list: add, remove, or modify. Next, the defacing module 506 applies this deface method to one of the submission's features (e.g., a point, line, or polygon). For the add method, the system draws a feature with random vertices. For the remove method, the system randomly removes one feature. For the modify method, the system shifts one feature in a random direction by five meters. At step 904, the defacing module 506 spawns a binary review task using the defaced submission. At step 906, if the worker passes a defaced submission, the system notifies the worker and counts it as a failed submission for the worker. The defacing module 506 supports configuring a variety of parameters including the percent of submissions defaced, the number of features to deface, the frequency with which to employ each of the defacing methods, and the amount to shift features when using the modify defacing method.

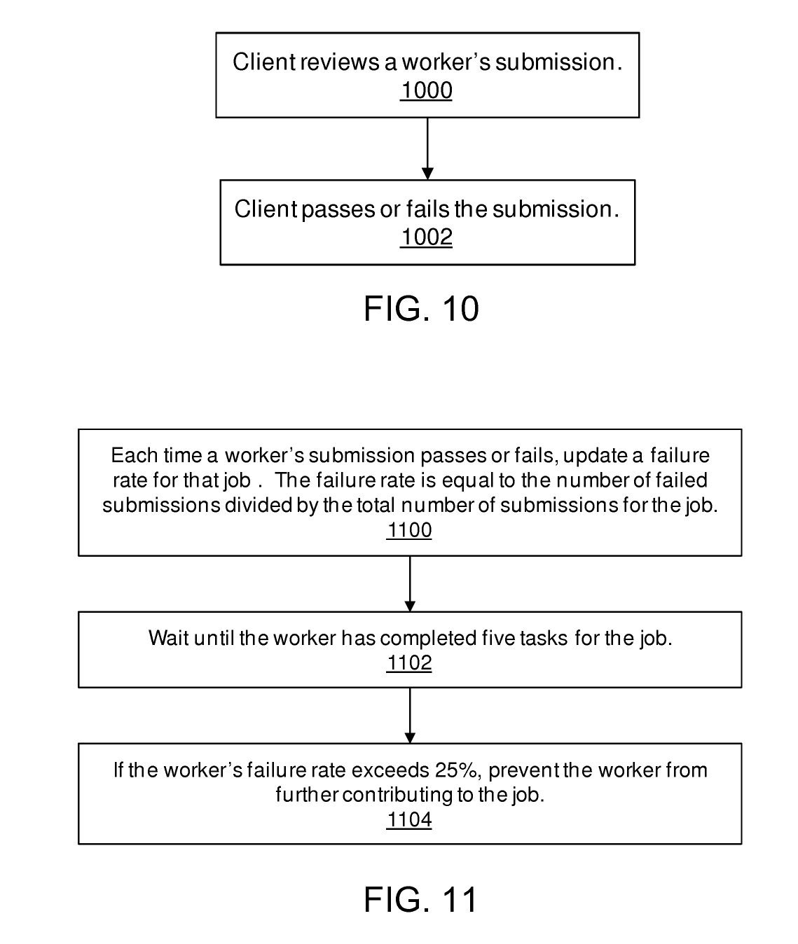

FIG. 10 shows further details of a client review module of the illustrative system and method of FIG. 5. In FIG. 10, the client review module 508 starts at step 1000 by enabling the client to review a worker's submission. At step 1002, the client can pass or fail the submission.

FIG. 11 shows further details of an eligibility module of the illustrative system and method of FIG. 5. In FIG. 11, the eligibility module 510 starts at step 1100 by updating a failure rate for a job each time a worker's submission passes or fails. The failure rate is equal to the number of failed submissions divided by the total number of submissions for the job. Submissions may fail during binary test, comparative test, or client review. Also, passing a defaced submission counts as a failed submission. At step 1102, the eligibility module 510 waits until the worker has completed five tasks for the job. This is the grace period. At step 1104, if the worker's failure rate exceeds 25% after the grace period, the eligibility module 510 prevents the worker from further contributing to a job. The eligibility module 510 supports configuring a variety of parameters including the number of tasks included in the grace period and the failure rate threshold.

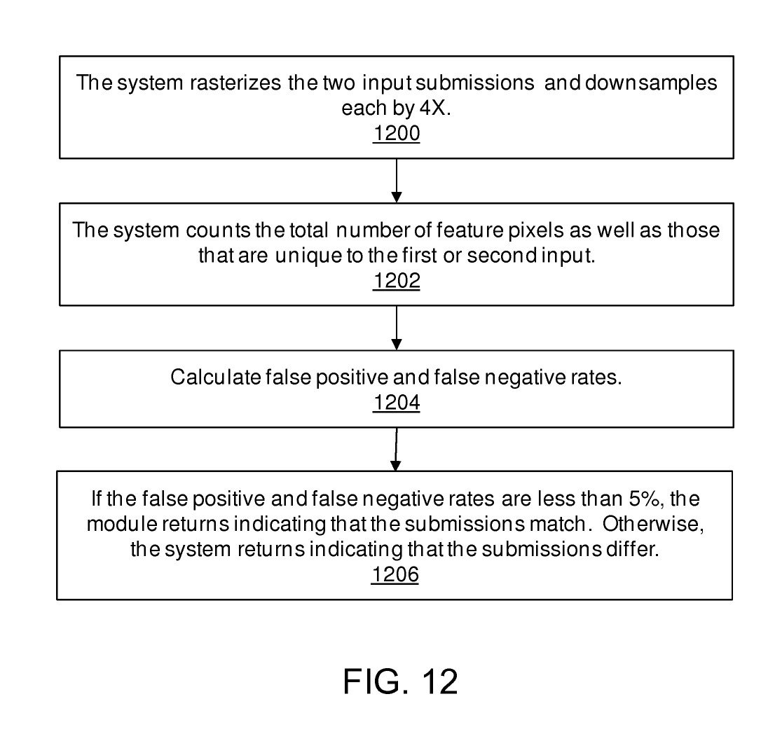

FIG. 12 shows an illustrative embodiment of the comparison module 512. The comparison module 512 starts at step 1200 by rasterizing two input submissions and downsampling each by 4×. At step 1202, the comparison module 512 counts the total number of feature pixels as well as those that are unique to the first and second inputs. At step 1204, the comparison module 512 calculates false negative and false positive rates. The false negative rate is the number of pixels unique to the first input divided by the total number of pixels. The false positive rate is the number of pixels unique to the second input divided by the total number of pixels. At step 1206, the comparison module 512 returns indicating a match if the rates are below 5%. Otherwise, the comparison module 512 returns indicating that the input submissions differ. The comparison module 512 supports configuring a variety of parameters including the downsampling rate and the false positive and false negative percentage thresholds.

Thus, the illustrative system, method, and computer program product can be configured for leveraging multiple workers to rapidly produce high-quality maps, including a client module (200), worker module (202), test module (204), and database (206). The client module (200) enables a client to log into the system and create a job, and divides the map production job into smaller tasks. The worker module (202) enables a worker to log into the system and perform these tasks. The test module (204) automatically enforces quality standards, and includes a qualification module (500), binary test module (502), comparative test module (504), defacing module (506), client review module (508), and eligibility module (510). The system also includes a database (206) including client, worker, and job information.

The above-described devices and subsystems of the illustrative embodiments of FIGS. 1 to 12 can include, for example, any suitable servers, workstations, PCs, laptop computers, PDAs, Internet appliances, handheld devices, cellular telephones, wireless devices, other electronic devices, and the like, capable of performing the processes of the illustrative embodiments of FIGS. 1 to 12. The devices and subsystems of the illustrative embodiments of FIGS. 1 to 12 can communicate with each other using any suitable protocol and can be implemented using one or more programmed computer systems or devices.

One or more interface mechanisms can be used with the illustrative embodiments of FIGS. 1 to 12, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, 3G communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments of FIGS. 1 to 12 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1 to 12 can be implemented via one or more programmed computer systems or devices.

To implement such variations as well as other variations, a single computer system can be programmed to perform the special purpose functions of one or more of the devices and subsystems of the illustrative embodiments of FIGS. 1 to 12. On the other hand, two or more programmed computer systems or devices can be substituted for any one of the devices and subsystems of the illustrative embodiments of FIGS. 1 to 12. Accordingly, principles and advantages of distributed processing, such as redundancy, replication, and the like, also can be implemented, as desired, to increase the robustness and performance the devices and subsystems of the illustrative embodiments of FIGS. 1 to 12.

The devices and subsystems of the illustrative embodiments of FIGS. 1 to 12 can store information relating to various processes described herein. This information can be stored in one or more memories, such as a hard disk, optical disk, magneto-optical disk, RAM, and the like, of the devices and subsystems of the illustrative embodiments of FIGS. 1 to 12. One or more databases of the devices and subsystems of the illustrative embodiments of FIGS. 1 to 12 can store the information used to implement the illustrative embodiments of the present disclosure. The databases can be organized using data structures (e.g., records, tables, arrays, fields, graphs, trees, lists, and the like) included in one or more memories or storage devices listed herein. The processes described with respect to the illustrative embodiments of FIGS. 1 to 12 can include appropriate data structures for storing data collected and/or generated by the processes of the devices and subsystems of the illustrative embodiments of FIGS. 1 to 12 in one or more databases thereof.

All or a portion of the devices and subsystems of the illustrative embodiments of FIGS. 1 to 12 can be conveniently implemented using one or more general purpose computer systems, microprocessors, digital signal processors, micro-controllers, and the like, programmed according to the teachings of the illustrative embodiments of the present disclosure, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1 to 12 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present disclosure can include software for controlling the devices and subsystems of the illustrative embodiments of FIGS. 1 to 12, for driving the devices and subsystems of the illustrative embodiments of FIGS. 1 to 12, for enabling the devices and subsystems of the illustrative embodiments of FIGS. 1 to 12 to interact with a human user, and the like. Such software can include, but is not limited to, device drivers, firmware, operating systems, development tools, applications software, and the like. Such computer readable media further can include the computer program product of an embodiment of the present disclosure for performing all or a portion (if processing is distributed) of the processing performed in implementing the illustrative embodiments of FIGS. 1 to 12. Computer code devices of the illustrative embodiments of the present disclosure can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present disclosure can be distributed for better performance, reliability, cost, and the like.

As stated above, the devices and subsystems of the illustrative embodiments of FIGS. 1 to 12 can include computer readable medium or memories for holding instructions programmed according to the teachings of the present disclosure and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present disclosure have been described in connection with a number of illustrative embodiments and implementations, the present disclosure is not so limited, but rather covers various modifications and equivalent arrangements, which fall within the purview of the appended claims.

What is claimed is:

1. A system for producing maps, the system comprising:
a client module for dividing a map production job into smaller tasks; and
a worker module for enabling workers to perform said tasks.

2. The system of claim 1, further comprising a test module for enforcing quality standards.

3. The system of claim 2, wherein said test module includes at least one of the following:
a qualification module for verifying that a worker is qualified to work on a task,
a binary test module for prompting workers to review and pass or fail a submission,
a comparative test module for assigning a task to multiple workers and comparing the results,
a defacing module for introducing errors into submissions,
a client review module for enabling a client to review and pass or fail a submission, and
an eligibility module for preventing failing workers from contributing to a job.

4. A system for producing maps, the system comprising:
a test module for enforcing quality standards wherein said test module includes at least one of the following:
a qualification module for verifying that a worker is qualified to work on a task,
a binary test module for prompting workers to review and pass or fail a submission,
a comparative test module for assigning a task to multiple workers and comparing the results,
a defacing module for introducing errors into submissions,
a client review module for enabling a client to review and pass or fail a submission, and
an eligibility module for preventing failing workers from contributing to a job.

5. The system of claim 4, further comprising:
a client module for dividing a map production job into smaller tasks; and
a worker module for enabling workers to perform said tasks.

6. A method for producing maps, the method comprising:
dividing by a client module a map production job into smaller tasks; and
enabling by a worker module workers to perform said tasks.

7. The method of claim 6, further comprising enforcing by a test module quality standards.

8. The method of claim 7, wherein said test module includes at least one of the following:
verifying by a qualification module that a worker is qualified to work on a task,
prompting by a binary test module workers to review and pass or fail a submission,
assigning by a comparative test module a task to multiple workers and comparing the results,
introducing by a defacing module errors into submissions,
enabling by a client review module a client to review and pass or fail a submission, and
preventing by an eligibility module failing workers from contributing to a job.

9. A method for producing maps, the method comprising:
enforcing by a test module quality standards wherein said test module includes at least one of the following:
verifying by a qualification module that a worker is qualified to work on a task,
prompting by a binary test module workers to review and pass or fail a submission,
assigning by a comparative test module a task to multiple workers and comparing the results,
introducing by a defacing module errors into submissions,
enabling by a client review module a client to review and pass or fail a submission, and
preventing by an eligibility module failing workers from contributing to a job.

10. The method of claim 9, further comprising:
dividing by a client module a map production job into smaller tasks; and
enabling by a worker module workers to perform said tasks.

11. A computer program product for producing maps and including one or more computer readable instructions embedded on a tangible, non-transitory computer readable medium and configured to cause one or more computer processors to perform the steps of:
dividing by a client module a map production job into smaller tasks; and
enabling by a worker module workers to perform said tasks.

12. The computer program product of claim 11, further comprising enforcing by a test module quality standards.

13. The computer program product of claim 12, wherein said test module includes at least one of the following:
verifying by a qualification module that a worker is qualified to work on a task,
prompting by a binary test module workers to review and pass or fail a submission,
assigning by a comparative test module a task to multiple workers and comparing the results,
introducing by a defacing module errors into submissions,
enabling by a client review module a client to review and pass or fail a submission, and
preventing by an eligibility module failing workers from contributing to a job.

14. A computer program product for producing maps and including one or more computer readable instructions embedded on a tangible, non-transitory computer readable medium and configured to cause one or more computer processors to perform the steps of:
enforcing by a test module quality standards wherein said test module includes at least one of the following:
verifying by a qualification module that a worker is qualified to work on a task,
prompting by a binary test module workers to review and pass or fail a submission,
assigning by a comparative test module a task to multiple workers and comparing the results,
introducing by a defacing module errors into submissions,
enabling by a client review module a client to review and pass or fail a submission, and
preventing by an eligibility module failing workers from contributing to a job.

15. The computer program product of claim 14, further comprising:
dividing by a client module a map production job into smaller tasks; and
enabling by a worker module workers to perform said tasks.
